(19) United States
(12) Patent Application Publication
(10) Pub. No.: US 2017/0121157 A1
(43) Pub. Date: May 4, 2017

(54) Security System for Operations in Wind Generators

(71) Applicant: Eliot Technology International Limited, Hong Kong (CN)

(72) Inventor: Jordi Masia Perales, Valencia (ES)

(21) Appl. No.: 15/315,806

(22) PCT Filed: Jun. 4, 2014
(86) PCT No.: PCT/ES2014/070456

§ 371 Date: Dec. 2, 2016

(51) Int. Cl. B66D 1/54; B66D 3/10; B66D 5/16; B66D 1/50

(52) U.S. Cl. CPC B66D 1/54; B66D 1/50; B66D 3/10; B66D 5/16; B66D 2700/026; B66D 2700/023

(57) ABSTRACT

A security system for operations in wind generators, applicable to wind generators with a hoisting point (2), includes a cable (3) which is attached by one end to the element to be secured, normally a robotised unit (4), and by the other end to a counterweight (8), such that the cable (3) passes through a locking system (61) and a first pulley (6) which are attached to the hoisting point (2). The counterweight (8) can be installed on a pulley block (7) with at least two branches. The system ensures the integrity of the tower-nacelle assembly (1) and the robotised unit (4) in the event of the latter being detached.

### TECHNICAL SECTOR

This invention refers to a safety device or system for operations on wind turbines, which enables a possible robot-driven unit, scaffolding, trolley or other item moving about the tower to be secured for maintenance, repair or cleaning work, protected from any falls or slips caused by losing its grip.

The invention is preferably for application in the field of the repair and maintenance of wind turbines and similar towers.

### STATE OF THE ART

For maintenance and cleaning operations on towers of wind turbines and similar items a robot-driven unit or some other item moving about the tower can be used, held on by its own devices. Since it is used at a great height and in areas of strong winds, safety measures nevertheless have to be taken in case it loses its grip and slips or falls to the ground from the tower.

Some crane manufacturers use items enabling pulling a steel cable located on the slow axle of the wind turbine (the one connected directly to the blades) (the TIRAK model made by TRACTEL for example) to raise heavy loads from the ground to the gondola or nacelle.

Apart from this, some of the commercially available gondolas or nacelles are already provided with a rear hoisting point for the nacelle, able to hold up to tonnes in weight. This rear point can be the starting point for the safety system according to the invention. The families of models G-4x and G-5x by Gamesa are cited as examples.

### BRIEF EXPLANATION OF THE INVENTION

The invention consists of a safety system according to the claims which offers the advantages stated. This is a safety system which protects both the robot-driven unit or any other item which is hoisted up beside the tower and the nacelle-tower assembly.

The anchorage of the safety system is directly on the wind turbine chassis, preferably at the nacelle's own hoisting point, the one used during its construction, which is thus a sturdy and consistent point which will have loads applied to this only in the event of the robot-driven unit slipping.

Furthermore, with the system considered dynamic loads have no incidence in the event of slipping since, as will be shown below, the system considers a locking system for the cable which acts in a very small margin of travel, normally under 50 mm, which means that dynamic loads can be ruled out in the event of any slipping of the robot-driven unit for cleaning or maintenance or any other element to be secured.

The most direct element for application of the invention is the safety of a robot-driven cleaning unit, which will normally have a mass of around 600 kg or less. In any event, the safety items may be oversized to ensure their effectiveness in the event of slipping for any item. For example, the cable can be defined with a minimum breaking load which is several times over the mass of the robot unit or in general of the item to be secured.

The safety system of the invention is based on mechanical simplicity and has taken into account both the safety of the element to be secured, normally the robot-driven unit, and the safety of the tower-nacelle assembly itself, also making it easier to set up the system on site. The safety system can be set up by an operator in roughly half an hour.

The invention covers a safety system for operations on wind turbines of the sort that have a nacelle with a hoisting point. The system comprises a cable fixed at one end of the item to be secured, normally a robot-driven unit, where said cable is also connected to a counterweight optionally forming part of a hoist. The cable goes through a system for locking any unwanted movement of said cable, fixed to the hoisting point, and a first pulley wheel to change the direction of the cable. The locking system will be what brakes any slipping of the item to be secured.

The system will preferably comprise a bush, for example made of polyester, at the point where the cable goes into the nacelle. This bush can be provided with a removable cap for when the safety system is not installed.

The counterweight should preferably be installed on a double or triple-reeved hoist to reduce the travel of the counterweight and its distance to the nacelle.

### DESCRIPTION OF THE DRAWINGS

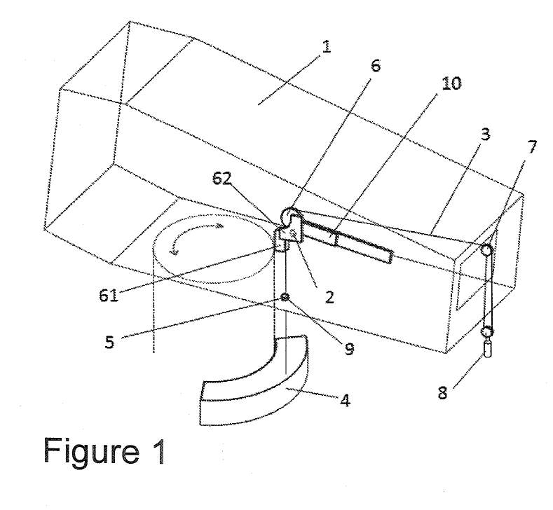

For a better understanding of the invention FIG. 1 is included, with a general diagram of the safety system described herein, in a preferred embodiment of this.

### FORMS OF EMBODIMENT OF THE INVENTION

One form of embodiment of the invention is described below, as an illustration without limiting this.

The safety system for operations on wind turbines (FIG. 1) starts from a gondola or nacelle (1) with a hoisting point (2) for assembling the nacelle (1). This hoisting point (2) is taken advantage of in the safety system to hold a cable (3) which will be joined to the element to be secured, normally a robot-driven unit (4), schematically represented, to hold this in the event of slipping. This robot-driven unit (4) could be a robot-driven unit (4) for cleaning the tower.

The cable (3) takes a route through the inside of the nacelle (1) from an entry point (5) on its lower side to a first pulley wheel (6) and a locking system (61) for the cable (3) in the event of any unwanted movement of the cable (3), and from said first pulley wheel (6) to a counterweight (8) of the cable (3). This counterweight (8) will preferably hang at a short distance from the nacelle (1) to minimise its swinging due to the effect of wind. This is preferably achieved by at least one hoist (7). This swinging is unwanted because it could make the counterweight (8) hit the tower or the robot-driven unit, or directly cause vibrations in the wind turbine structure. The distance and the mass of the counterweight (8) will depend, amongst other items, on how many times the hoist system (7) is reeved.

The entry point (5) of the cable (3) in the nacelle (1) could be protected by a bush (9), made for example of polyester, which prevents the cable (3) from rubbing against the wall of the nacelle (1). The bush (9) may have a plug which closes this when the safety system is dismantled.

The entry point (5) shall preferably be arranged under the support structure (62) of the locking system (61). This support structure (62) could be taken advantage of to also hold the first pulley wheel (6). The hoist (7) should be anchored, for example, to the rear door of the nacelle (1). Normally the hoisting point (2) is fixed to an element of the chassis (10) of the nacelle (1). Other arrangements (for example, having a plurality of pulley wheels over which the cable (3) runs) are nevertheless similarly possible within the scope of the invention.

The join of the cable (3) to the robot-driven unit (4) implies that, when this rises up the tower the cable (3), is collected thanks to the counterweight (8) remaining taut. The counterweight (8) will advance less than the robot-driven unit (4) thanks to the hoist (7). Hence, if this is the double-reeved type represented in FIG. 1, it will advance half as much. Keeping the cable (3) taut by means of the counterweight (8), this helps the robot-driven unit (4) to work in the optimum conditions.

The locking system (61) of the cable (3), which has been shown close to the first pulley wheel (6), is an essential item of the invention, as this is what really breaks the slipping or stops the robot-driven unit (4) from coming off.

This locking system (61) can be made for example of a “Blocstop” (registered trade mark) system, marketed by the company Tractel, joined to the support structure (62) of the first pulley wheel (6). Other commercial locking systems (61) can be applied such as the one indicated in patent ES475700, also made by Tractel. These locking systems detect any loss of tension in a cable, or any major increase of speed, and can proceed to secure this in its position.

In the event of the robot-driven unit (4) slipping or coming off, the locking system (61) will restrain the cable (3) transmitting the loads proper to the robot's weight to the hoisting point (2) of the nacelle (1). In the event of any slipping the robot-driven unit (4) will only need a very short travel of the cable to come to a complete halt (for example at most 50 mm with the locking system (61) described above). The final position in the event of any slipping will therefore be practically the same as before slipping.

The first pulley wheel (6) and/or one of the cable (3) guides, preferably has retaining means to confine and secure its travel in the system, preferably comprising one or more guide plates which keep the cable (3) in the slot of the first pulley wheel (6), or other means known in the state of the art.

The system used in the invention enables having one end of the cable (3) fixed to the robot-driven unit (4) with no need for the cable (3) to go through (this will thus prevent any damage to the hydraulic hoses).

What is claimed is:

1. A safety system for operations on wind turbines, of the type that have a nacelle with a hoisting point, comprising:
a cable fixed at one end to an element to be secured,
a counterweight secured to the other end of the cable,
a locking system of the cable fixed to the hoisting point and
a first pulley wheel through which said cable runs.

2. A safety system according to claim 1, further comprising a bush at an entry point of the cable in the nacelle.

3. A safety system according to claim 2, further comprising a removable cap for the bush.

4. A safety system according to claim 1, wherein the counterweight is installed on a hoist.

5. A safety system according to claim 4, wherein the hoist is a double-reeved pulley block.

6. A safety system according to claim 1, further comprising a retaining arrangement for preventing the cable from escaping from at least one of:
the first pulley wheel and
at least one guide of said cable.

7. A safety system according to claim 1, wherein the retaining arrangement comprises at least one plate keeping the cable in a slot of the first pulley wheel.

8. A safety system according to claim 1, wherein the element to be secured is a robot-driven unit.

9. A safety system according to claim 8, wherein the robot-driven unit is a robot-driven unit for cleaning a tower of a wind turbine.
